(19) United States
(12) Patent Application Publication
(10) Pub. No.: US 2012/0209651 A1
(43) Pub. Date: Aug. 16, 2012

(54) Online booking for team of professionals

(76) Inventors: Kenneth Cameron, Bristol (GB); Christopher Gledhill, Bristol (GB)

(21) Appl. No.: 13/396,096

(22) Filed: Feb. 14, 2012

Related U.S. Application Data
(60) Provisional application No. 61/442,785, filed on Feb. 14, 2011.

(51) Int. Cl. G06Q 10/10

(52) U.S. Cl. 705/7.15; 705/7.13

(57) ABSTRACT

A method and apparatus for an online booking system for independent professionals such as personal trainers who also work as part of a series of distinct but potentially overlapping teams.

### FIELD OF THE INVENTION

The present invention relates to electronic booking systems allowing instructors to maintain an electronic booking facility and a parallel booking diary. Even more particularly, the present invention relates to an electronic booking system with support for groups of instructors to form teams.

### BACKGROUND OF THE INVENTION

There are many coaches, instructors and other professionals offering tuition/services to people in a large variety of sports and other skills. Examples range from tennis coaches and golf professionals to mobile hairdressers and masseuses. For the most part they are self-employed, operating all aspects of their business themselves. A key aspect of successful business of this type is the maintaining of a healthy diary of future bookings. Although many bookings are made by existing customers, at the conclusion of a previous booking, this does not account for all bookings. As the coaches maintain their own diaries, they are usually contacted by their clients via mobile phone. The use of internet based, online booking is being adopted by these coaches and removes the need for both parties to directly communicate to arrange a booking.

Many such professionals may work as members of a team, for example as fitness trainers operating from a specific gym. Each will still maintain their own diary but must now also communicate with the team owner, the gym, in the previous example.

### Limitations of the State of the Art

Online booking systems consist of a database containing details of each user of the system. A proportion of the users, are able to make their diary available, to allow the remaining users to book their time.

Existing online booking systems take one of two forms. In the first form, each trainer is completely independent of other trainers, fully managing their own diary. Such systems are an efficient way to provide online booking capability to a large set of unconnected trainers, but enforce this independence. Each trainer must specify to the system any resources they need to manage their diary. Typical such resources include locations, booking types, availability and equipment.

In the second form, a dedicated booking system is provided for a team of trainers. This team is typically limited to working for a single organisation that provides the booking system. Such systems have the advantage over the first form of booking system, that resources can be specified once and shared between all trainers. But, trainers who work for more than one organisation, or also work independently find that they must use multiple independent booking systems.

### SUMMARY OF THE INVENTION

The current invention seeks to address the limitations of the first form of online booking system, without introducing the constraints of working within a system dedicated to a specific team.

The invention provides an online booking system of the first form that is specifically adapted to group trainers into teams. In the preferred implementation of the invention, the team is a user of the system, identified as the team owner and having all the properties of a user.

In a particular implementation, the team owner can invite a trainer to become a member of the team and the trainer only becomes a member of the team if the trainer accepts the invitation. A trainer may request team membership and only becomes a member of the team if the team owner agrees to the request. This symmetry allows either the team owner or trainer to withdraw team membership, either temporarily or permanently. There is no limit to the number of teams a trainer can potentially join. Additional control information is held that limits the ability of a trainer to join or leave a specific team or allows a team owner access to a trainer account.

One particular aspect of this invention is that in addition to providing the information usually provided by a trainer, a team also provides aggregate information about the team.

In a particular implementation, a list of team members is displayed.

In another implementation, a composite diary is displayed for the team, combining all of team members group sessions or classes into a single diary similar in presentation to the diary of an individual trainer.

In the preferred implementation, trainers can make use of resources created by the team owner, mixing these with their own resources. A gym may define a set of locations shared by all the trainers who operate at it, while each trainer offers distinct booking types. An activity franchise may define a common set of booking types, but each trainer specifies their own set of locations.

The above description extends to the control mechanisms used to restrict the types of bookings that a client is able to make, such that not only the rules specified by particular trainer but also the rules specified by the team owner where a resource (booking type say) belongs to the team owner.

In another implementation trainers and team owners are able to specify that resources are equivalent and can be used interchangeably.

### BRIEF DESCRIPTION OF THE DRAWINGS

FIG. 1 shows the typical setup of an online booking system

FIG. 2 shows a typical trainer homepage on an online booking system.

FIG. 3 shows a possible team homepage on an online booking system that includes the current invention.

FIG. 4 shows a preferred team membership status record

FIG. 5 shows a hierarchical set of teams.

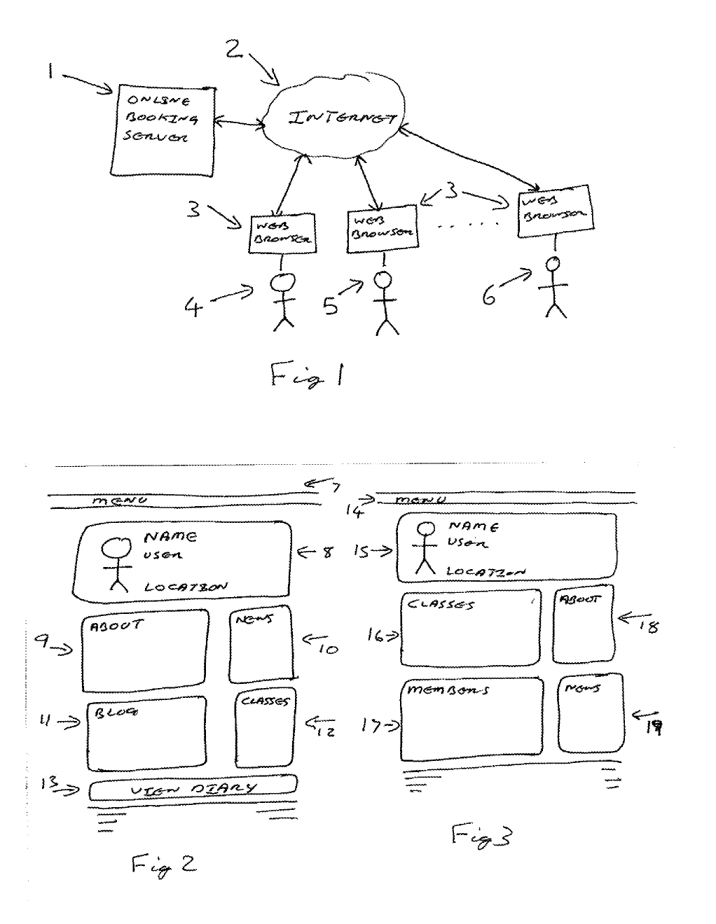

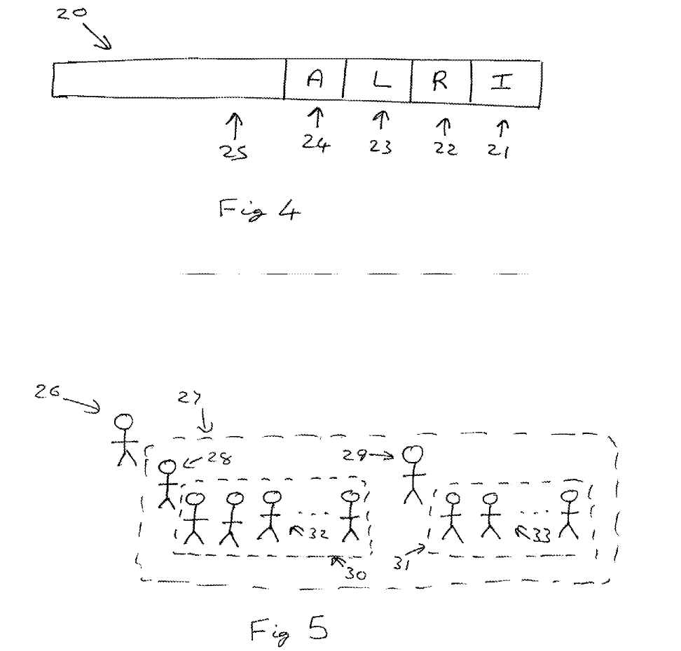

### DETAILED DESCRIPTION OF THE INVENTION

The current invention extends the capability of an online booking system (1) accessed via the internet (2) by multiple users (4,5,6) to support grouping the users into teams. The users preferably access the booking system via a web browser (3) however alternative methods such as a dedicated application on a mobile device or SMS (short message service) are also possible.

In the preferred embodiment a team is a new type of user that has most of the features of a trainer, excluding a diary of its own. All trainers have a homepage on the system that provides a fixed location on the internet that clients can find the trainer.

The system presents a homepage with a different type of content for team owners. A team owners homepage includes a representation of all the active team members (17). These representations provide a link to each team members respective homepage. A number of filtering options can be provided by the system based on information stored. This can include those trainers available for specific types of one to one session, or who have time available to book within a specified period.

A team home page may also include a diary listing (16) all of the group sessions offered by members of the team. The diary would have similar appearance to an individual trainers diary with entries organised by date and time.

Teams are constructed by a combination of the desire of a team owner to have a specific trainer be a team member (21) and for the specific trainer to wish to be a team member (22). Only if both conditions are met, will the trainer appear as a team member. A record of the membership must also include an identifier of the team owner and the specific trainer to which it relates.

Within a management page the team owner will be shown the three groups of trainers that represent the possible states of membership. These are active (I+R), invited (I+˜R) and requested (˜I+R).

Within the same or a different management page trainers are shown the three groups of teams that represent the possible states of membership. These are active (I+R), invited (I+˜R) and requested (˜I+R).

Although a team owner (26,28,29) can own only one team in the preferred embodiment, the trainers may be members of more than one team. One way in which a team owner is similar to a trainer is that a team owner can also be a team member (28,29) of one or more teams.

Team owners should not be members of their own team.

A team owner can change the I state at anytime and a trainer can change the R state at anytime, unless the state indicates that it is locked (23) in which case it may not be altered.

An additional status indicator (24) allows a team owner to access the specific trainers account as if they were the trainer. This provides a mechanism for team owners to manage a diary on behalf of a trainer.

The system allows trainers to create locations and booking types (either group or individual) in order to set up and manage their online bookings. In the preferred embodiment, trainers are permitted to use the locations and booking types created by a team owner as if they were their own. This also includes any locations or booking types created by a team owners team owner (26, 32, 33)

On systems where pre-paid packages of sessions or subscriptions are available, this permits clients to purchase the package/subscription from the team owner and use it with any member of the team that uses that booking type.

On systems where trainers are able to specify which clients are permitted (or not) to book a particular booking type, the current invention extends those rules to include the booking types created by team owners of whose team a trainer is an active member.

The team owner will also have their own rule set and can use this to control the availability of booking types both to end clients and also trainers. Thus a rule that denies a trainer a team owners booking type does not mean they cannot make that booking but instead that they cannot offer it to their clients.

An alternative implementation of resource sharing is the maintenance of a record of equivalence between two or more resources. It provides a means for a team owner to provide booking type credits to a client that can then be used with one or more team members. It also allows a trainer to create equivalences between their own resources. However it requires each team member to create a resource to which the team owners resource and be made equivalent.

1. An apparatus for providing online booking for teams of professionals comprising:
an online booking system providing online booking for a plurality of first and second users where the first users are able to control membership of a team by the second users and the second users are able to be members of more than one team,
an interface capable of displaying a plurality of aggregate information about the members of a team.

2. An apparatus as in claim 1,
wherein the aggregate information includes a diary comprising the combined contents of a plurality of second users diaries presented in a similar manner to a diary of a single user where the second users are all member of the same team.

3. An apparatus as in claim 1,
wherein a second user is able to use a plurality of resources belonging to a first user as if the resources belonged to the second user when the second user is a member of a team controlled by the first user.

4. An apparatus as in claim 1,
wherein a first user is able to access a diary of a second user as if the first user where the second user when the second user is a member of a team controlled by the first user.

5. A method for providing online booking for teams of professionals comprising the steps of providing online booking for a plurality of first and second users where the first users are able to control membership of a team by the second users and the second users are able to be members of more than one team,
displaying a plurality of aggregate information about the members of a team.

6. A method as in claim 5 comprising the further step of displaying a diary comprising the combined contents of a plurality of second user's diaries presented in a similar manner to a diary of a single user where the second users are all members of the same team.

7. A method as in claim 5 comprising the further step of allowing a second user to use a plurality of resources belonging to a first user as if the resources belonged to the second user when the second user is a member of a team controlled by the first user.

8. A method as in claim 5 comprising the further step of allowing a first user to access a diary of a second user as if the first user where the second user when the second user is a member of a team controlled by the first user.
